(19) United States
(12) Patent Application Publication
(10) Pub. No.: US 2007/0285635 A1
(43) Pub. Date: Dec. 13, 2007

(54) EXPOSURE APPARATUS, REMOVAL METHOD, AND DEVICE MANUFACTURING METHOD

(76) Inventor: Masami YONEKAWA, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/757,581

(22) Filed: Jun. 4, 2007

(30) Foreign Application Priority Data
Jun. 9, 2006 (JP) 2006-160513
May 25, 2007 (JP) 2007-138628

(51) Int. Cl. G03B 27/52

(52) U.S. Cl. 355/30; 355/53

(57) ABSTRACT

An exposure apparatus that exposes onto a substrate a pattern of a mask that is located in a vacuum or reduced atmosphere and includes a multilayer film that is made of a lamination of a molybdenum layer and a silicon layer includes a laser irradiation unit for irradiating onto the mask a pulsed laser beam that has a wavelength of 200 nm or below.

### BACKGROUND OF THE INVENTION

1. Field of the Invention

The present invention relates to an exposure apparatus.

2. Description of the Related Art

Currently, a vigorous research and development progresses to realize a semiconductor device having a critical dimension (“CD”) of 100 nm or smaller in the design rule in manufacturing a semiconductor device, such as a DRAM and a MPU. A projection exposure apparatus that uses the EUV light having a wavelength of about 10 nm and 15 nm, which will be referred to as a “EUV exposure apparatus” hereinafter, calls an attention as an exposure apparatus that efficiently manufactures such a fine semiconductor device.

In general, the projection exposure apparatus illuminates a circuit pattern of a mask (reticle) and transfers or projects an image of the circuit pattern onto a wafer via a projection optical system, for example, by reducing a size of the pattern by 1/4. When a particle adheres to a patterned plane of the mask, on which a circuit pattern is formed, a particle image is transferred at a corresponding position of each shot, and the yield of a semiconductor device manufacture or the reliability of the semiconductor device remarkably lowers.

A conventional exposure apparatus that uses the g-line, the i-line, the KrF excimer laser, or the ArF excimer laser for a light source provides a mask with a transparent protective film (i.e., pellicle) which has a high transmittance to the exposure light. The pellicle is distant from the patterned plane by several millimeters, and prevents particles' adhesions to the circuit pattern. The particle adhered to the pellicle is defocused from the patterned plane (or object plane), and is not transferred as a defective image on the wafer if its size is smaller than the predetermined size.

Since there is no material having a high transmittance to the EUV light in the EUV exposure apparatus, the pellicle is required as thin as scores of nanometers to meet the transmittance requirement. However, such a thin pellicle runs short of both the mechanical strength to pressure changes of the atmosphere (from the air pressure to the vacuum atmosphere or vice versa), and the thermal strength to temperature rises due to EUV light absorptions.

The EUV exposure apparatus needs to use a pellicleless mask that has no pellicle. When the particle occurs in the apparatus, its adhesion to the patterned plane is concerned. In manufacturing a device in the 35 nm design rule, for example, a particle of 0.1 μm adhered to the patterned plane causes a particle image of 25 nm to be transferred on the wafer with a projection optical system that has a reduction ratio of 1/4, making the device manufacture impossible. Indeed, due to an increasingly reducing particle diameter to be controlled (or which should be kept away from the patterned plane), even a fine particle of scores of nanometers or smaller that has adhered to the patterned plane would make the device manufacture impossible.

Probably, particles generated in the apparatus are derived from operations (e.g., slides and frictions) of a mask stage, a robot hand, and a gate valve, and debris dispersed from a light source. In particular, a frictionally generated particle is charged and it is said that this particle causes, even when the mask is grounded to 0V, a force called an image effect between the particle and the mask, inducing the particle adhesion to the mask. In addition, the EUV exposure apparatus provides exposure in the vacuum atmosphere, and the mask is fed in and out through a load lock chamber. Therefore, in vacuum-pumping the load lock chamber, the particles in the load lock chamber curl up due to the airflow and adhere to the patterned plane.

The generated particles are not subject to fluid resistance but subject only to the gravity because of few gas molecules in the vacuum atmosphere. In this state, it is reported that the particle that has approximately elastically collided with the chamber's internal wall recoils in the chamber.

Some technologies are proposed for the EUV exposure apparatus to remove the particle that has adhered to the patterned plane by irradiating the pulsed laser beam onto the mask's patterned plane while maintaining the vacuum atmosphere. See Japanese Patent Publication No. 6-95510 (corresponding to U.S. Pat. No. 4,980,536 A1) and Japanese Patent Laid-Open No. 2000-088999 (corresponding to U.S. Pat. No. 6,385,290 B1). Japanese Patent Publication No. 6-95510 irradiates a laser beam to remove the particles that have adhered to the patterned plane. The laser beam has a power density that causes no damages of the mask's patterned plane, but can remove the particles. Japanese Patent Laid-Open No. 2000-088999 introduces the inert gas into the chamber, irradiates the pulsed laser beam to the patterned plane, and removes the particle.

A mechanism of the particle's generation and a behavior in the vacuum atmosphere is not fully analyzed, and thus a countermeasure to the particle that has adhered to the mask's patterned plane is insufficient. For example, a pulsed laser beam irradiated as in the prior art onto the particle that has adhered to the patterned plane cannot sometimes remove the particle, and does not always effectively remove the particles.

### BRIEF SUMMARY OF THE INVENTION

The present invention is directed to an exposure apparatus that effectively removes a particle that has adhered to the patterned plane of the mask to improve the exposure characteristic.

An exposure apparatus that exposes onto a substrate a pattern of a mask that is located in a vacuum or reduced atmosphere and includes a multilayer film that is made of a lamination of a molybdenum layer and a silicon layer includes a laser irradiation unit for irradiating onto the mask a pulsed laser beam that has a wavelength of 200 nm or below.

Further features of the present invention will become apparent from the following description of exemplary embodiments with reference to the attached drawings.

### BRIEF DESCRIPTION OF THE DRAWINGS

FIG. 1 is a schematic sectional view showing a structure of an exposure apparatus according to one aspect of the present invention.

FIG. 2 is an enlarged sectional view showing a laser irradiation unit of the exposure apparatus shown in FIG. 1.

FIGS. 3A-3C are schematic plane views each showing a positional relationship between a mask position, an irradiated position of a pulsed laser beam, and an irradiated position of the EUW light in the exposure apparatus shown in FIG. 1.

FIG. 4 is a schematic plane view showing a positional relationship between the mask position, the irradiated position of the pulsed laser beam, and the irradiated position of the EUV light in the exposure apparatus shown in FIG. 1.

FIG. 5 is a graph showing a removal ratio of a sample particle that has adhered to a Si substrate.

FIG. 6 is a graph showing a removal ratio of a sample particle that has adhered to a Si substrate coated with a Ru film.

FIG. 7 is a graph showing a calculation result of the absorption intensity of the Si substrate, which depends upon a wavelength of the pulsed laser beam.

FIG. 8 is a graph showing a calculation result of the absorption intensity of the Si substrate coated with the Ru film, which depends upon a wavelength of the pulsed laser beam.

FIG. 9 is a schematic sectional view showing one illustrative structure of a mask in the exposure apparatus shown in FIG. 1.

FIG. 10 is a schematic sectional view showing one illustrative structure of a mask in the exposure apparatus shown in FIG. 1.

FIG. 11 is a graph showing a particle removal experimental result for the mask having a Mo/Si multilayer film.

FIG. 12 is a schematic sectional view showing one illustrative structure of a laser irradiation unit in the exposure apparatus shown in FIG. 1.

FIG. 13 is a schematic sectional view showing one illustrative structure of the mask in the exposure apparatus shown in FIG. 1.

FIG. 14 is a schematic sectional view showing one illustrative structure of a laser irradiation unit in the exposure apparatus shown in FIG. 1.

FIG. 15 is a flowchart for explaining a fabrication of a device.

FIG. 16 is a flowchart for a wafer process of step 4 shown in FIG. 15.

FIG. 17 is a graph showing a removal ratio of sample particles that have adhered to the Si substrate.

### DESCRIPTION OF THE EMBODIMENTS

Referring now to the accompanying drawings, a description will be given of an exposure apparatus according to one aspect of the present invention. In each figure, the same reference numeral designates the same element, and a duplicate description thereof will be omitted.

Initially, the instant inventor studied a principle of the particle removal technology using the pulsed laser so as to effectively remove the particle that has adhered to the mask's pattern plane and to provide an exposure apparatus that has an excellent exposure characteristic.

When the pulsed laser beam (“PLB”) irradiation in the ns order quickly thermally expands a particle and the mask (or its patterned plane), and the generated acceleration exceeds the particle's adhesion power, the particle is separated or removed from the mask. This mechanism does not fully explain all the phenomena concerning the particle removal, and is complicatedly involved with both photochemical and light pressure aspects. This first approximation almost reveals the experimental result notwithstanding.

It is understood from this result that the effective particle removal depends upon the physical properties of the mask (or the multilayer film in the mask) to which the particle adheres, in particular, the absorption ratio of the mask relating to the irradiated PLB's wavelength. Similarly, the effective particle removal depends upon the absorption ratio of a material of the particle to the irradiated PLB's wavelength.

Accordingly, the present invention addresses the PLB'S wavelength irradiated onto the mask, and provides a method for more effectively removing or reducing the particle than the prior art.

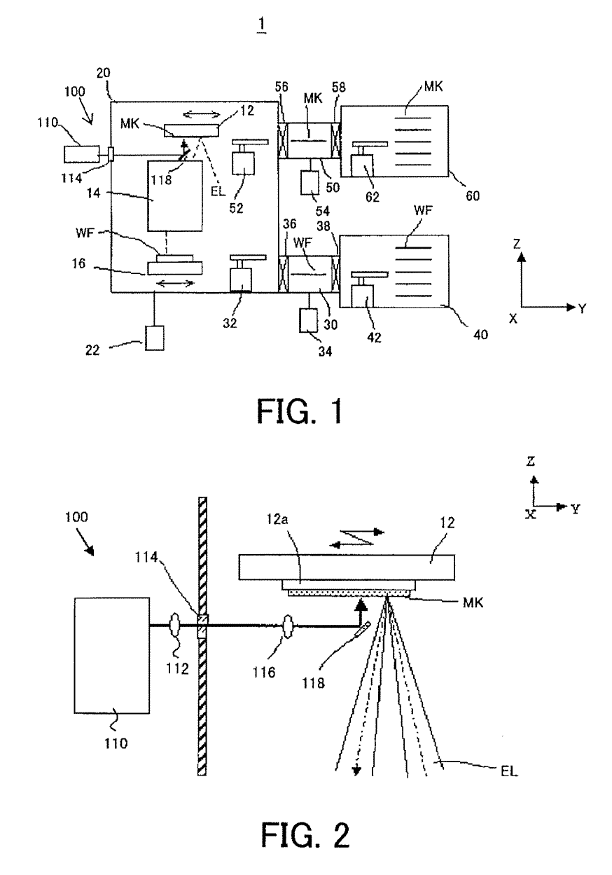

FIG. 1 is a schematic sectional view showing a structure of an exposure apparatus 1 according to one aspect of the present invention. The exposure apparatus 1 is a projection exposure apparatus that uses, as the exposure light, EUV light EL (e.g., with a wavelength of 13.5 nm) to expose a circuit pattern of a mask onto a substrate. The exposure apparatus 1 is a step-and-scan exposure apparatus, but the present invention can use a step-and-repeat manner or another type of exposure apparatus.

Referring to FIG. 1, WF is a wafer that serves as a substrate, and MK is a reflection mask having a circuit pattern. 12 denotes a mask stage that holds the mask MK, and provides fine and rough movements to the mask MK in a scan direction. 14 denotes a projection optical system that projects the EUV light EL reflected on the mask MK onto the wafer WF. 16 denotes a wafer stage that holds the wafer WF, and provides fine and rough movements to the wafer WF in six axes directions. A XY coordinate of the wafer stage 16 is always monitored by a laser interferometer (not shown).

Since the exposure apparatus 1 is a step-and-scan exposure apparatus, the circuit pattern of the mask MK is transferred onto the wafer WF when the mask MK and the wafer WF are scanned at a speed ratio corresponding to the reduction ratio. For example, the scan speeds of the mask stage 12 and the wafer stage 16 are controlled so as to satisfy Vr/Vw=β, where 1/β is a reduction ratio of the projection optical system 14, Vr is the scan speed of the mask stage 12, and VW is the scan speed of the wafer stage 16.

The exposure apparatus 1 exposes the wafer WF in the vacuum atmosphere. Therefore, each unit of the above exposure apparatus 1 is accommodated in an exposure chamber 20. The exposure chamber 20 is vacuum-pumped by a vacuum pump 22, and its inside is maintained at the vacuum atmosphere.

30 denotes a wafer-side load lock chamber, and 32 denotes a transport hand that transports the wafer WF in and out between the wafer-side load lock chamber 30 and the wafer stage 16. 34 denotes a vacuum pump that vacuum-pumps the wafer-side load lock chamber 30. The vacuum pump 34 is used together with a source of a ventilation gas, such as dry N₂ and dry air, to return the vacuum atmosphere to the air pressure.

36 denotes an apparatus-side gate valve that isolates the exposure chamber 20 from the wafer-side load lock chamber 30. 38 denotes an exchange-chamber-side gate valve that isolates the wafer-side load lock chamber 30 from a wafer exchange chamber 40, which will be described later.

The wafer exchange chamber 40 stores the wafers WFs at the air pressure. 42 denotes a transport hand that feeds in and out a wafer WF between the wafer-side load lock chamber 30 and the wafer exchange chamber 40.

50 denotes a mask-side load lock chamber, and 52 denotes a transport hand that feeds in and out the mask MK between the mask-side load lock chamber 50 and the mask stage 12. 54 denotes a vacuum pump that vacuum-pumps the mask-side load lock chamber 50. The vacuum pump 54 is used together with a source of a ventilation gas, such as dry N₂ and dry air, to return the vacuum atmosphere to the air pressure.

56 denotes an apparatus-side gate valve that isolates the exposure chamber 20 from the mask-side load lock chamber 50. 58 denotes an exchange-chamber-side gate valve that isolates the mask-side load lock chamber 50 from a mask exchange chamber 60, which will be described later.

The mask stores the masks MKs at the air pressure. 62 denotes a transport hand that feeds in and out the mask MK between the mask-side load lock chamber 50 and the mask exchange chamber 60.

100 denotes a laser irradiation unit that serves as removal means for removing a particle that has adhered to the mask MK's patterned plane having a circuit pattern. The laser irradiation unit 100 includes, as shown in FIG. 2, a light source 110, a shaping optical system 112, an inlet window 114, a condenser optical system 116, and a mirror 118. FIG. 2 is an enlarged sectional view showing a structure of the laser irradiation unit 100.

In FIG. 2, the EUV light EL from an illumination optical system (not shown) is reflected on the mask MK's patterned plane, and incident upon the projection optical system 14. 12a denotes a chuck holder that holds or attracts the mask MK, and provided on the mask stage 12 via a fine movement mechanism (not shown). During exposure, the mask stage 12 repeats an acceleration, a constant velocity, and a deceleration in the Y-axis direction shown in FIG. 2 for scanning.

The light source 110 emits a PLB that is the light having a wavelength of 200 nm or smaller. The light source 110 uses, for example an ArF excimer laser (having a wavelength of about 193 nm), and an F₂ laser (having a wavelength of about 157 nm). For the light source 110, a light source having a wavelength of 200 nm or greater, such as the KrF excimer laser (having a wavelength of about 248 nm) and, a YAG laser (having a wavelength of about 266 nm).

The shaping optical system 112 shapes the PLB emitted from the light source 110 into a collimated beam. The inlet window 114 is made of an optical material, such as quartz glass, which little absorbs the incident wavelength (or the wavelength of the EUV light), and provided on the exposure chamber 20. The condenser optical system 116 condenses the PLB shaped into the collimated beam on a shape necessary to remove or reduce the particle. The mirror 118 deflects the PLB emitted from the condenser optical system 116 towards the mask MK's patterned plane.

In the laser irradiation unit 100, the PLB emitted from the light source 110 is shaped by the shaping optical system 112 into the collimated beam, and introduced into the exposure chamber 20 via the inlet window 114. The PLB introduced to the exposure chamber 20 is condensed by the condenser optical system 116, deflected by the mirror 118 that can change the incident angle, and irradiated on the mask MK's patterned plane.

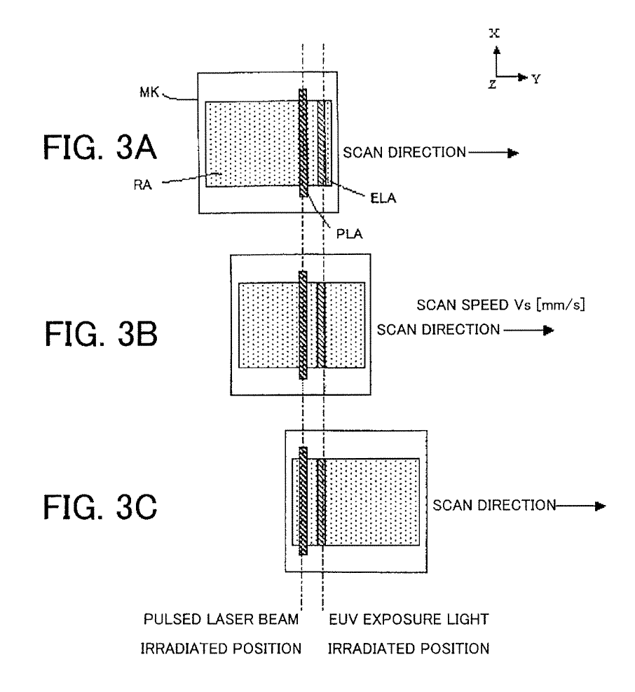

FIG. 3 is a schematic plane view showing a positional relationship between a PLB irradiated position, and an irradiated position of the EUV light EL. This embodiment shapes the PLB irradiated onto the mask MK's patterned plane in a sheet shape that is long in the X-axis direction orthogonal to the scan or Y-axis direction.

In FIG. 3, RA is a removal range in which the particles are removed from the mask MK's patterned plane. PLA is an irradiation range in which the PLB is irradiated. The irradiation range PLA is long enough to cover the removal range RA in the X-axis direction orthogonal to the mask scan direction or the Y-axis direction. ELA is an illumination range in which the EUV light EL is irradiated. The illumination range ELA has a rectangular shape in this embodiment, but may have an arc shape depending upon a characteristic of the illumination optical system (not shown).

The PLB is irradiated on the patterned plane near the illumination range ELA in the scan direction of the mask MK, as shown in FIG. 3A, so that the irradiation range PLA is located in front of the illumination range ELA. Thereby, when the mask MK is scanned, the PLB is irradiated on the entire removal range RA as shown in FIGS. 3B and 3C, and removes the particles that have adhered to the patterned plane. In other words, the irradiation range PLA moves on the entire removal range RA utilizing scanning or reciprocating of the mask MK. The irradiation range PLA in front of the illumination range ELA can remove the particles from the illumination range ELA before the EUV light EL is irradiated when the mask MK is scanned.

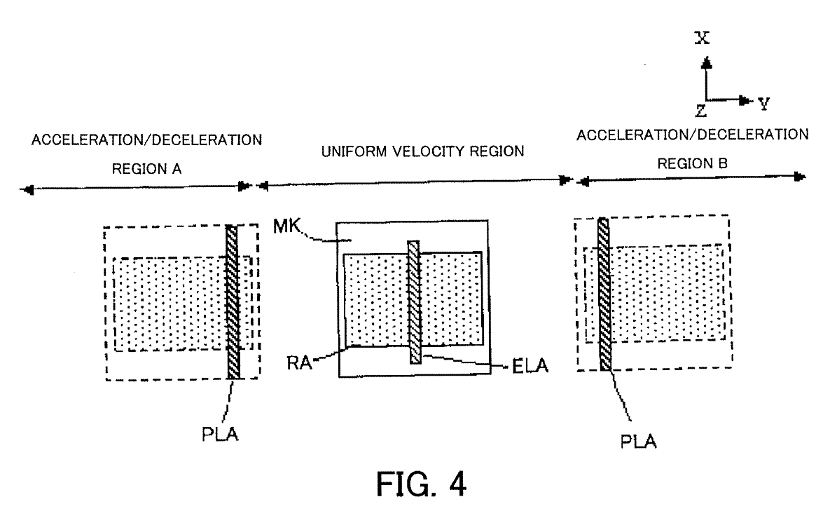

The irradiation range PLA in which the PLB is irradiated may be set at least one of the regions A and B in which the mask MK accelerates and decelerates, for example, as shown in FIG. 4. FIG. 4 is a schematic plane view showing a positional relationship among the mask MK's position, the PLB irradiated position, and the irradiated position of the EUV light EL.

A description will now be given of an experimental result with the PLB's wavelength that can effectively remove the particles that have adhered to the patterned plane of the mask MK.

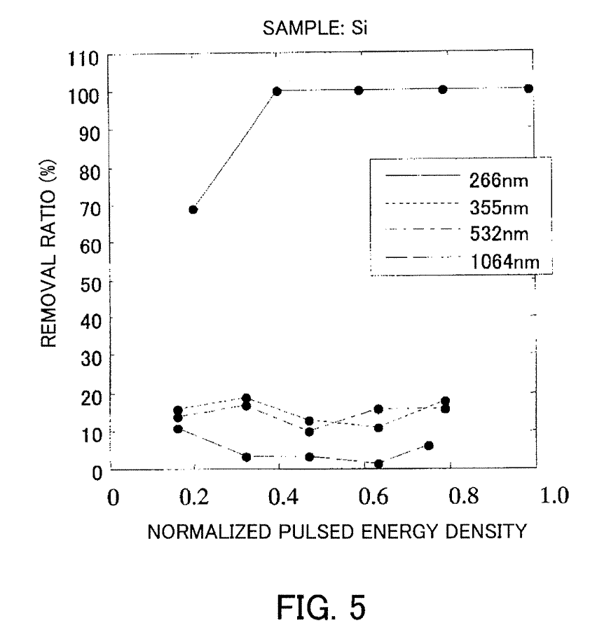

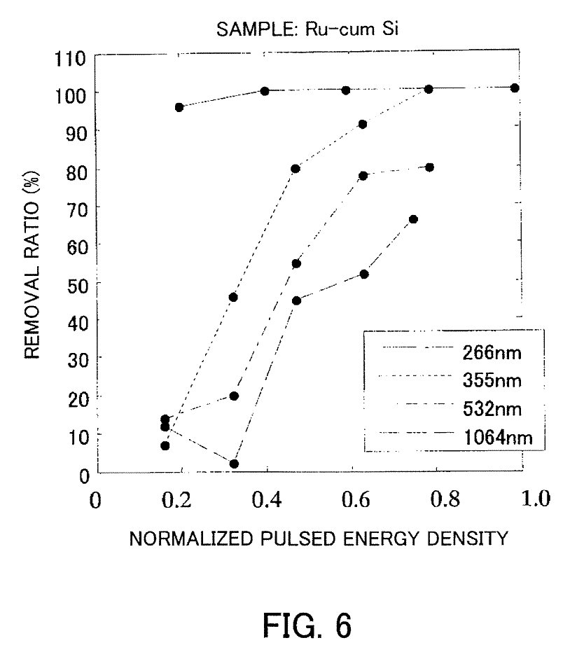

As a substrate from which the particles are removed, a Si substrate and a Si substrate coated with a Ru film were prepared, and sample particles (PSL (poly styrene latex) particles) to be removed were adhered to the surfaces of these substrates. The number of pulses of the irradiated PLB was made constant, and the wavelength dependency of the PSL particle's removal ratio was studied while the pulse energy density [mJ/cm²] was changed. The irradiated PLBs have wavelengths of 266 nm, 355 nm, 532 nm, and 1064 nm. FIG. 5 is a graph showing an experimental result with the Si substrate, and FIG. 6 is a graph showing an experimental result of the Si substrate coated with the Ru film. In FIGS. 5 and 6, the ordinate axis denotes a removal ratio [%], and the abscissa axis denotes the normalized pulse energy density.

Referring to FIG. 5, the PSL particle removal ratio of the Si substrate reduces as the PLB wavelength becomes longer. On the other hand, it is understood from FIG. 6 that the PSL particle removal ratio of the Si substrate coated with the Ru film improves even when the PLB wavelength becomes longer. This is because the absorption characteristic of the substrate (material) closely depends upon the wavelength.

Transmitting intensity I when the light is incident upon a material is generally given by the Beer's law as Equation 1 below:

I/I₀=exp(−α×Z) EQUATION 1

I₀ is the incident light intensity, α is an absorption coefficient of the material to the incident light wavelength, and Z is a thickness of the material.

Referring to Equation 1, as the absorption coefficient α becomes higher, I/I₀ decreases. Hence, as the light quantity absorbed in the material increases, and the material temperature rapidly rises. On the other hand, as the absorption coefficient α becomes lower, I/I₀ increases. Therefore, the light quantity absorbed in the material decreases, and the material temperature hardly rises.

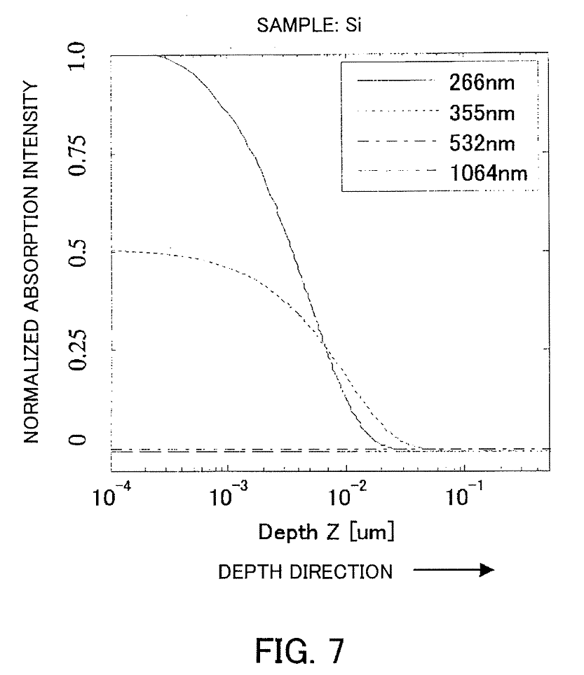

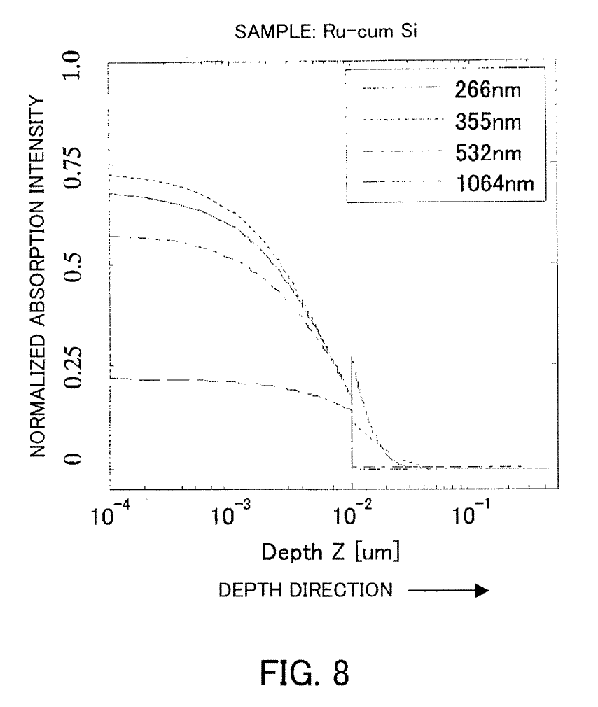

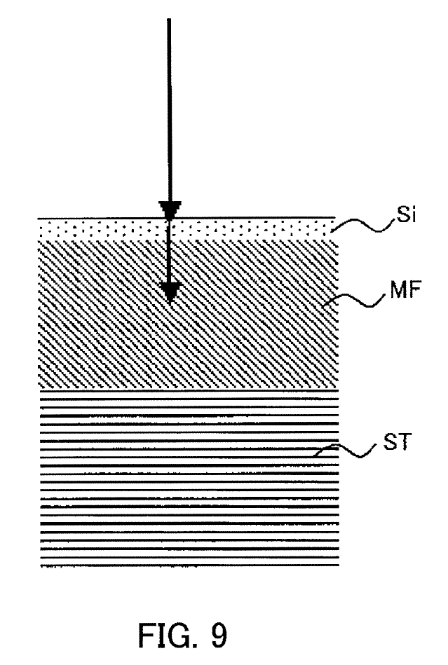

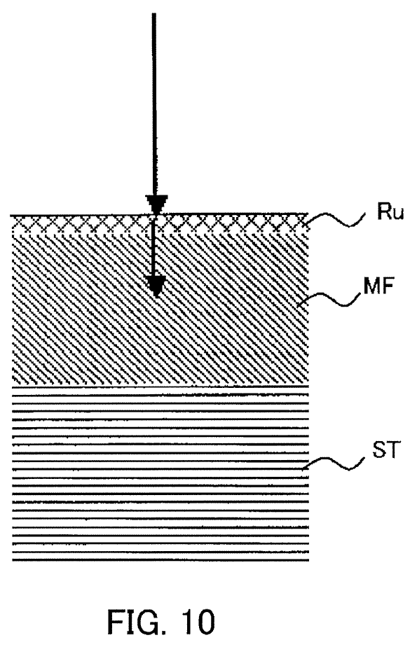

FIG. 7 shows a calculation result of the absorption intensity of the Si substrate to the PLB wavelength. FIG. 8 is a calculation result of the absorption intensity of the Si substrate coated with the Ru film to the PLB wavelength. In FIGS. 7 and 8, the abscissa axis denotes the depth [μm] from the substrate, and the ordinate axis denotes the pulsed laser absorption intensity per unit volume.

Referring to FIG. 7, the Si substrate absorbs the PLB having a wavelength of 266 nm, but almost transmits PLBs having (long) wavelengths of 532 nm and 1064 nm and therefore the absorptions of these pulsed lasers are 0. Thus, the irradiated PLB of 266 nm is absorbed on the surface of the Si substrate, and the Si substrate thermally expands in the ns order and removes the PSL particles. On the other hand, the irradiated PLBs of 532 nm and 1064 nm are hardly absorbed on the surface of the Si substrate, and the Si substrate does not thermally expand and can hardly remove the PSL particles.

The Si substrate coated with the Ru film changes the absorption intensity as shown in FIG. 8. In particular, the PLB having a long wavelength is absorbed, which is not absorbed in the Si substrate, and the substrate thermally expands in the ns order, and appears to improve the PSL particles removal efficiency.

The particle removal is complicatedly entangled with other factors, such as a photochemical factor and a light pressure factor, and is not fully elucidated by the above description. However, it is almost reasonable from the first approximation that the light absorption characteristic of each material is closely related to the particle removal.

From the above experimental result and consideration, it is presumed that the particle can be effectively removed from an actual reflection mask when a wavelength having an absorption characteristic to the mask (more particularly a multilayer film in the mask) is selected for the PLB's wavelength.

A mask having a Mo/Si multilayer film that laminates a molybdenum layer and a silicon layer shown in FIGS. 9 and 10 was prepared, and the particle removal experiment was performed with the same condition as the above experiment. The mask shown in FIG. 9 has a mask substrate ST, a Mo/Si multilayer film MF that laminates a molybdenum layer and a silicon layer, and a Si film as a capping layer at the uppermost surface. The mask shown in FIG. 10 has a mask substrate ST, a Mo/Si multilayer film MF that laminates a molybdenum layer and a silicon layer, and a Ru film as a capping layer at the uppermost surface.

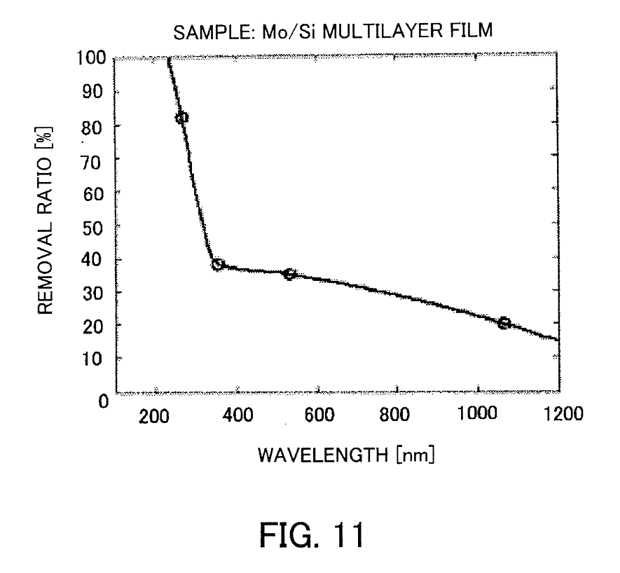

FIG. 11 is a graph showing a particle removal experiment result to the mask having the Mo/Si multilayer film. FIG. 11 plots an approximation curve based on the experimental result, where the abscissa axis denotes the PLB wavelength, and the ordinate axis denotes the removal ratio [%]. Referring to FIG. 11, as the PLB's wavelength becomes shorter, in particular, in the EUV light wavelength region, the removal ratio rapidly increases. It is understood that as the PLB's wavelength becomes much shorter, for example, down to 200 nm or smaller, the removal ratio of 100% can be easily achieved. The irradiated PLB has a time width of 7-10 ns, and the energy density per pulse is 50 mJ/cm² although the energy density depends upon the experimental condition.

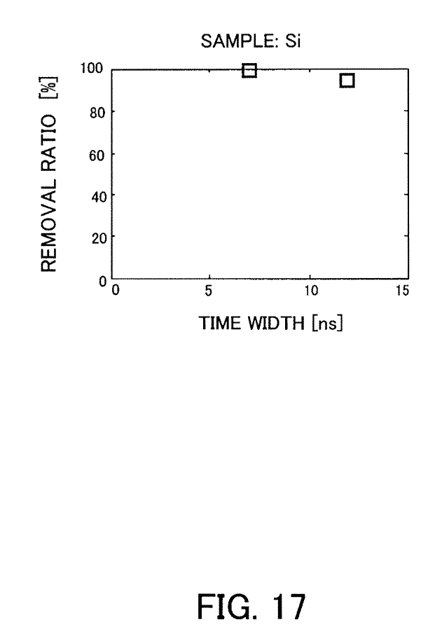

FIG. 17 shows an experimental result when a time width of the laser pulse is varied using the laser having the same wavelength range. In FIG. 17, an abscissa axis denotes the time width of the laser pulse [ns], and an ordinate axis denotes a removal ratio [%]. It is understood from FIG. 17 that the removal efficiency is almost equal between the pulse's time width of 7 nm and that of 12 nm. From this result, it is understood that a sufficient removal ratio is available in a range of the pulse's time width equal to or smaller than 15 nm.

The damage of the mask's patterned plane due to the PLB irradiation closely depends upon the energy density per pulse, and does not depend upon an integrated value of the irradiated PLB energy. This fact is confirmed by a series of experimental results by this inventor. Therefore, the smaller energy density per pulse is preferable in view of the damage of the mask's patterned plane.

This experimental result has revealed that the energy density of 50 mJ/cm² or greater is likely to damage the mask's patterned plane although the result depends upon the experimental condition. In addition, a time width longer than 15 ns needs a higher energy density to completely remove the particle, damaging the mask's patterned plane.

Hence, the PLB having a wavelength of 200 nm or smaller, a time width of 15 ns or smaller, and an energy density of 50 mJ/cm² or smaller when irradiated onto the mask would completely remove the particle from the mask's patterned plane without damaging it.

As discussed above, since the particle removal ratio differs according to structures of the mask MK or its multilayer film, the laser irradiation unit 100 is preferably configured to change or select a PLB to be irradiated onto the mask MK.

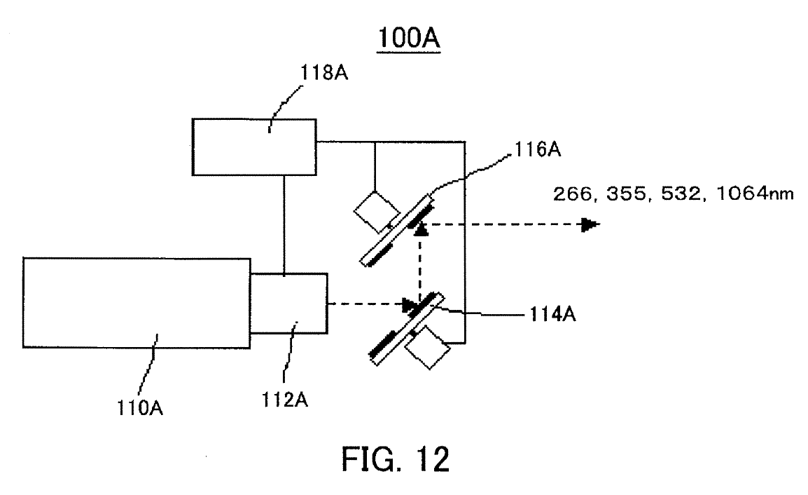

FIG. 12 is a schematic sectional view of a structure of a laser irradiation unit 100A that has a wavelength changing part that changes or selects the PLB wavelength to be irradiated onto the mask MK. The laser irradiation unit 100A includes, as shown in FIG. 12, an oscillator 110A, a harmonic generator 112A, harmonic separators 114A and 116A, and a wavelength conversion controller 118A, and these components constitute the wavelength changing part.

The oscillator 110A oscillates the basic wavelength 1064 nm of the YGA laser. The harmonic generator 112A generates a basic wavelength 1064 nm, a second harmonic of 532 nm, a third harmonic of 355 nm, and a fourth harmonic 266 nm.

The harmonic separators 114A and 116A separates the harmonic generated by the harmonic generator 112A into a specific wavelength. The harmonic separators 114A and 116A include, for example, a mirror that reflects only a predetermined wavelength, and a holder that rotatably holds the mirror.

The wavelength conversion controller 118A selects the best wavelength for the particle removal, and controls the harmonic generator 112A and harmonic separators 114A and 116A based on the selection result. In other words, the wavelength conversion controller 118A irradiates a PLB having the best wavelength for the particle removal onto the mask MK via the harmonic generator 112A and harmonic separators 114A and 116A.

Thus, the laser irradiation unit 100A does not limit the wavelength of the irradiated PLB to 200 nm or below, and changes the wavelength to the best wavelength for the particle removal. For example, the capping layer in the multilayer film having the mask MK is not limited to the Si or Ru film, and another material is applicable. Then, the laser irradiation unit 100A can change or select the wavelength according to a material of the capping layer.

As shown in Table 1 below, a material of the absorption layer of the mask MK's pattern exhibits an approximately flat absorption characteristic to the PLB's wavelength to be irradiated. In Table 1, Ta and Cr are illustrative absorption layers.

TABLE 1

| | 266 nm | 355 nm | 532 nm | 1064 nm |
|---|---|---|---|---|
| Ta | 82 | 83 | 75 | 63 |
| Cr | 106 | 113 | 106 | 51 |

unit: /nm

When a particle has adhered to the absorption layer, the wavelength is not restricted to the one that depends upon the material of the capping layer in the multilayer film, as discussed above, and the PLB may have a long wavelength. In that case, the PLB wavelength irradiated onto the mask MK is preferably selectable as in the laser irradiation unit 100A.

In general, the photon energy is given by Expression 2 below:

E=hν EQUATION 2

h is a Planck's constant, and ν is a frequency of the light.

The shorter the wavelength of the light is, the higher the photon energy is. When the PLB is irradiated onto a fine structure, the light having a longer wavelength is less likely to damage the structure if the energy density is made constant.

When a particle that adheres to the mask MK is relatively large and is likely to remove, a PLB having a long wavelength is used rather than a PLB having a short wavelength to remove the particle without damaging the mask MK.

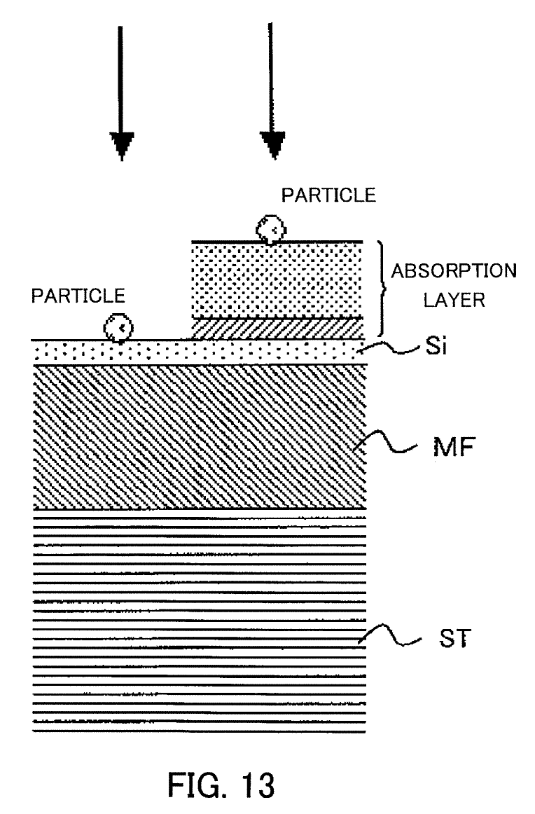

The best wavelength for the particle removal depends upon a material of the capping layer in the multilayer film in the mask MK. The mask MK for the EUV exposure apparatus has an absorption layer made of a material, such as Ta and Cr, on the capping layer in the Mo/Si multilayer film MF as shown in FIG. 13. The absorption layer forms a circuit pattern of the mask MK. In that case, the PLB having the best wavelength for the absorption layer, and the PLB having the best wavelength for the capping layer are simultaneously irradiated to effectively remove the particles. Here, FIG. 13 is a schematic sectional view of an illustrative structure of the mask MK.

The particle removal ratio depends upon the particle that adheres to the patterned plane. In actually running the exposure apparatus 1, a wavelength that can effectively remove the particle can be specified once a main ingredient of the particle that disperses in the apparatus is specified or assumed. Even in this case, the PLB having the best wavelength for the particle, the PLB having the best wavelength for the absorption layer, and the PLB having the best wavelength for the capping layer are simultaneously irradiated to effectively remove the particles.

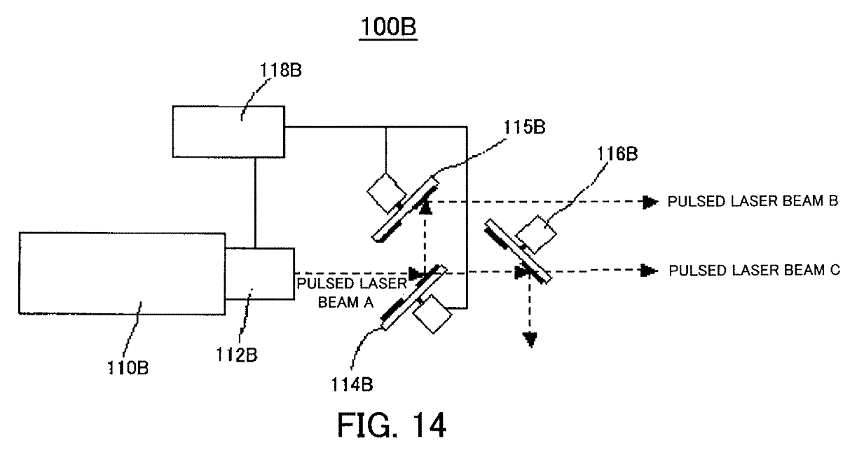

FIG. 14 is a schematic sectional view showing a structure of a laser irradiation unit 100B that simultaneously irradiates plural PLBs having different wavelengths onto the mask MK. The laser irradiation unit 100B includes, as shown in FIG. 14, an oscillator 110B, a harmonic generator 112B, wavelength separating mirrors 114B, 115B, and 116B, and a wavelength conversion controller 118B. The oscillator 110B, the harmonic generator 112B, and the wavelength conversion controller 118B are similar to the oscillator 110A, the harmonic generator 112A, and the wavelength conversion controller 118A in the laser irradiation unit 100A.

The PLB having a wavelength of 1064 nm incident upon the harmonic generator 112B from the oscillator 110B constitutes a PLB A that is a combination of one or more PLBs having other wavelengths than the basic harmonic, such as 532 nm, 355 nm, and 266 nm. The PLB A forms PLBs B and C when combined with the wavelength separating mirrors 114B, 115B, and 116B each having wavelength selectivity. Table 2 shows the wavelengths of the PLBs A to C:

TABLE 2

| PLB A | PLB B | PLB C |
|---|---|---|
| 1064 nm, 532 nm | 532 nm | 1064 nm |
| 1064 nm, 532 nm, 355 nm | 355 nm | 1064 nm |
| 1064 nm, 532 nm, 355 nm | 355 nm | 532 nm |
| 1064 nm, 532 nm, 266 nm | 266 nm | 1064 nm |
| 1064 nm, 532 nm, 266 nm | 266 nm | 532 nm |

Thus, the laser irradiation unit 100B can simultaneously irradiate plural PLBs having different wavelengths onto the mask MK, and more effectively remove the particle. The laser irradiation unit 100B of this embodiment uses PLBs having two different wavelengths (i.e., PLBs B and C), but more than two PLBs having different wavelengths may be simultaneously irradiated.

Thus, the exposure apparatus 1 can effectively remove the particle that has adhered to the mask MK's patterned plane through the laser irradiation units 100 to 10B, and exhibits an excellent exposure characteristic.

In exposure, the EUV light EL emitted from the EUV light source (not shown) illuminates the mask MK through the illumination optical system (not shown). The light that is reflected on the mask MK and reveals the circuit pattern is imaged on the wafer WF via the projection optical system 14. The exposure apparatus 1 can effectively remove the particle that has adhered to the mask MK, as discussed above, and precisely transfer the circuit pattern of the mask MK to the wafer WF. Thereby, the exposure apparatus 1 can provide a higher quality device, such as a semiconductor device and a liquid crystal display device.

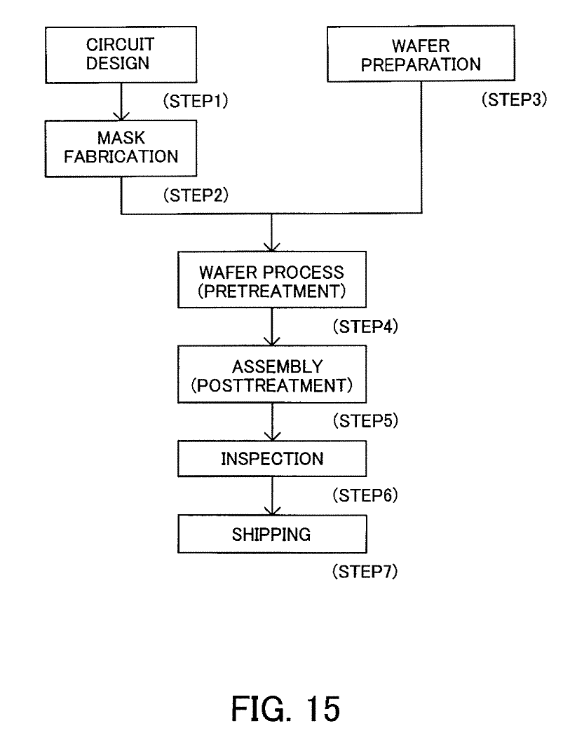

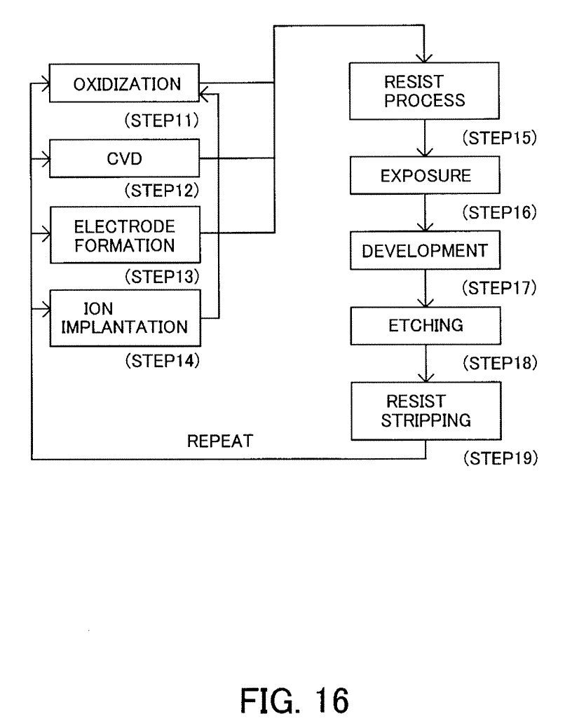

Referring now to FIGS. 15 and 16, a description will be given of an embodiment of a device manufacturing method using the above exposure apparatus 1. FIG. 15 is a flowchart for explaining how to fabricate devices (i.e., a semiconductor device and a liquid crystal display device). Here, a description will be given of the fabrication of a semiconductor device in an example. Step 1 (circuit design) designs a device circuit. Step 2 (mask fabrication) forms a mask having a designed circuit pattern. Step 3 (wafer preparation) manufactures a wafer using a material such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 16 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatuses 1 to expose a circuit pattern of the mask onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device manufacturing method of this embodiment may manufacture higher quality devices than ever. Thus, the device manufacturing method using the exposure apparatus 1, and a resultant device also constitute one aspect of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-160513, filed on Jun. 9, 2006 and 2007-138628, filed on May 25, 2007, which is hereby incorporated by reference herein in its entirety.

What is claimed is:

1. An exposure apparatus that exposes onto a substrate a pattern of a mask that is located in a vacuum or reduced atmosphere and includes a multilayer film that is made of a lamination of a molybdenum layer and a silicon layer, said exposure apparatus comprising a laser irradiation unit for irradiating onto the mask a pulsed laser beam that has a wavelength of 200 nm or below.

2. An exposure apparatus according to claim 1, wherein the laser irradiation unit irradiates the pulsed laser beam having an energy density of 50 mJ/cm² per pulse at a time width of 15 ns or smaller.

3. An exposure apparatus that exposes onto a substrate a pattern of a mask that is located in a vacuum or reduced atmosphere and includes a multilayer film and an absorption layer, said exposure apparatus comprising a laser irradiation unit for irradiating onto the mask a pulsed laser beam, the laser irradiation unit including a wavelength changing part for changing a wavelength of the pulsed laser beam to be irradiated onto the mask.

4. An exposure apparatus according to claim 3, wherein the wavelength changing part changes the wavelength of the pulsed laser beam based on at least one of a particle that has adhered to the mask, a material of the absorption layer, and a material of the multilayer film.

5. An exposure apparatus that exposes onto a substrate a pattern of a mask that is located in a vacuum or reduced atmosphere and includes a multilayer film and an absorption layer, said exposure apparatus comprising a laser irradiation unit for simultaneously irradiating plural pulsed laser beams having different wavelengths onto the mask.

6. An exposure apparatus according to claim 5, wherein the wavelength changing part changes the wavelength of the pulsed laser beam based on at least one of a particle that has adhered to the mask, a material of the absorption layer, and a material of the multilayer film.

7. A removal method for reducing or removing a particle that has adhered to a mask that is located in a vacuum or reduced atmosphere and includes a multilayer film that is made of a lamination of a molybdenum layer and a silicon layer, said removal method comprising the step of irradiating onto the mask a pulsed laser beam having a wavelength of 200 nm or smaller.

8. A removal method according to claim 7, wherein the pulsed laser beam has an energy density of 50 mJ/cm² per pulse at a time width of 15 nm or smaller.

9. A removal method for reducing or removing a particle that has adhered to a mask that is located in a vacuum or reduced atmosphere and includes a multilayer film and an absorption layer, said removal method comprising the steps of:
irradiating onto the mask a pulsed laser beam; and
changing a wavelength of the pulsed laser beam based on at least one of a particle that has adhered to the mask, a material of the absorption layer, and a material of the multilayer film.

10. A removal method for reducing or removing a particle that has adhered to a mask that is located in a vacuum or reduced atmosphere and includes a multilayer film and an absorption layer, said removal method comprising the step of irradiating onto the mask plural pulsed laser beams having different wavelengths based on at least one of a particle that has adhered to the mask, a material of the absorption layer, and a material of the multilayer film.

11. A device manufacturing method comprising the steps of:
exposing a substrate using an exposure apparatus according to claim 1; and
developing the substrate that has been exposed.
